(19) United States
(12) Patent Application Publication
(10) Pub. No.: US 2024/0420053 A1
(43) Pub. Date: Dec. 19, 2024

(54) METHOD AND SYSTEM FOR TASK DISTRIBUTION IN AN ORGANIZATION

(71) Applicant: Milan Madhavji, Mississauga (CA)

(72) Inventor: Milan Madhavji, Mississauga (CA)

(21) Appl. No.: 18/365,716

(22) Filed: Aug. 4, 2023

(30) Foreign Application Priority Data
Jun. 13, 2023 (CA) 3203201

(51) Int. Cl. G06Q 10/0633; G06Q 10/0631; G06Q 10/1093

(52) U.S. Cl. CPC G06Q 10/0633; G06Q 10/063112; G06Q 10/063114; G06Q 10/1097

(57) ABSTRACT

There is provided a method for assigning a task to a worker including identifying a plurality of task types within which each task of a plurality of tasks is classifiable, prioritizing each type relative one another, sorting the tasks into a queue according to relative priority of the type with which each task is associated, identifying a plurality of worker profiles each having a subset of task types assignable to a worker associated with the profile and a weighting for each task type of the subset, and, assigning to one worker one task from the queue which corresponds with at least one task type of the subset of the profile, the one task being prioritized relative to other tasks in the queue according to relative priority of the type and where the type of the one task is weighted according to the weighting associated with the type of the subset.

### TECHNICAL FIELD

The present disclosure generally relates to automated workflow management systems. More particularly, the present disclosure relates to methods and systems, including computer-implemented methods and systems for distributing tasks among workers in an organization.

### BACKGROUND

Success in an organization depends on efficient use of its workforce. Many organizations include workers of various types including managers, professionals and support staff, all of whom should have tasks efficiently allocated thereto for successful operation of the organization. With the advent of large-scale remote work, workforces have become more geographically and temporally distributed. Remote or hybrid work has become the norm for many businesses. One consequence of this transition into remote or hybrid work, businesses are increasingly adopting systems to facilitate efficient management of their workforces.

Many systems, some of which are computerized or software-driven systems, have been deployed in various organizations promising efficient management of the workforce by distributing tasks to specific workers having a predetermined availability, authorization, skillset or level of experience needed to perform that task. Other systems may simply queue all tasks to be performed within the organization and then assign a next task to a next worker absent any consideration of the availability or skillset of the worker. Moreover, systems which simply assign tasks to users and track progress often result in work backlogs and lead to inefficient and wasteful use of organizational resources. This may leave individual workers to take their own initiative to decide what tasks need to be done and what priority those tasks receive. If certain tasks become backlogged, it may be left to individual workers or management to identify the issue and manually reassign the work in order to accommodate these transient backlogs or to identify whether tasks are over capacity or under-utilized.

The aforementioned systems do not accurately reflect the manner in which a human manager would allocate its workforce. A human manager sets priorities for the organization and allocates the workforce accordingly in order to meet those priorities. This may mean that some tasks are given a lower level of priority than other tasks. Moreover, the priority may change over time. The priorities from one day, week or month may not carry over to another day, week or month, as the case may be. Also, a human manager should consider that exceptions may sometimes have to be made. For example, if a task set as a lower priority suddenly, due to a change in circumstances, becomes urgent before organizational priorities are next assessed, a worker in the workforce should be allocated to that task to ensure it is completed. In addition, it may be desirable for a manager to allocate a worker with a particular skillset to a task or subset of tasks which does not have a strong correlation with the skillset of that worker. Such a worker allocation may take place for training purposes or in instances where an experienced worker may be put in a position to oversee an unfamiliar type of project, for example. The aforementioned systems are not sufficient for these purposes.

It therefore desirable to have a system for distributing tasks among workers in an organization which meets the shifting priorities of the organization over time.

### SUMMARY

The present disclosure generally relates to automated workflow management systems. More particularly, the present disclosure relates to methods and systems, including computer-implemented methods and systems for distributing tasks among workers in an organization.

In one aspect, there is provided a computer implemented method for assigning a task to a worker in an organization. The method includes identifying a plurality of task types within which each task of a plurality of tasks is classifiable, prioritizing each task type of the plurality of task types relative to one another, sorting the plurality of tasks into a task queue according to relative priority of the task type with which each task of the plurality of tasks is associated, identifying a plurality of worker profiles, each worker profile having a subset of task types assignable to a worker associated with the worker profile and an adjustable assignment weighting for each task type of the subset of task types, and, assigning to one worker one task from the task queue which corresponds with at least one task type of the subset of task types of the worker profile associated with the one worker, the one task being prioritized for assignment relative to other tasks in the task queue according to relative priority of the task type with which the one task is associated and where the task type of the one task is weighted according to the adjustable assignment weighting associated with the at least one task type of the subset of task types. The method may further include removing the one task from the task queue after assignment to the one worker.

Prioritizing each task type of the plurality of task types relative to one another may include associating a task type priority value with each task type of the plurality of task types.

Identifying the plurality of worker profiles may further include obtaining a real-time availability status of each worker profile of the plurality of worker profiles. Identifying the plurality of worker profiles may further include obtaining a geographic location of the worker associated with the worker profile. The one task in the task queue may be assignable only to workers available to receive the one task. The one worker may become unavailable to receive further tasks after receiving the one task.

Prior to assigning, the method may further include disabling at least one task type of the subset of task types of the worker profile associated with the worker whereby tasks of the disabled at least one task type are unassignable to the one worker as the one task.

Assigning the one task may include self-assignment of the one task by the worker. Assigning the one task to the one worker may be automatic upon completion of a previously assigned task.

Prioritizing each task type of the plurality of task types relative to one another may further include associating an adjustable urgency weighting with each task type of the plurality of task types, and sorting the plurality of tasks into a task queue is further based on the adjustable urgency weighting associated with each task type.

Prioritizing each task type of the plurality of task types relative to one another may further be based on metadata. The metadata may include a status of a prerequisite task or a number of tasks in the task queue.

Each worker profile of the plurality of worker profiles may further include a worker skill weighting associated with each task type of the subset of task types in the worker profile. Assigning to one worker one task from the task queue may further include prioritizing for assignment of the one task one worker among a plurality of workers where the one worker has a corresponding worker profile where the subset of task types includes a task type corresponding with the task type of the one task and a worker skill weighting associated therewith that is higher than the worker skill weighting associated with the same task type in any of the subset of task types of other worker profiles among the plurality of workers.

In one aspect, the method may further include directing the one task to a worker other than the one worker for review of the one task after completion of the one task for providing feedback on the performance thereof. The method may further include directing the one task to the one worker after feedback is provided for acknowledgement of the feedback.

In one aspect, there is provided a system for assigning a plurality of tasks among workers in an organization. The system includes a task type module for identifying a plurality of task types within which each task of the plurality of tasks is classifiable, a task type prioritization module for prioritizing each task type of the plurality of task types relative to one another, a task queue module for sorting the plurality of tasks into a task queue in order of relative priority of the task type with which each task of the plurality of tasks is associated, a worker profile module for identifying a plurality of worker profiles each having a subset of task types assignable to a worker associated with the worker profile and an adjustable assignment weighting for each task type of the subset of task types, and, an assignment module for assigning to one worker one task from the task queue which corresponds with at least one task type of the subset of task types of the worker profile associated with the one worker, the one task being prioritized for assignment relative to other tasks in the task queue according to relative priority of the task type with which the one task is associated and where the task type of the task is weighted according to the adjustable assignment weighting associated with the at least one task type of the subset of task types. The system may further include a module for removing the one task from the task queue after assignment to the one worker.

The task type prioritization module may associate a task type priority value with each task type of the plurality of task types for prioritizing each task type of the plurality of task types relative to one another.

The system may further include a worker scheduling module for obtaining a real-time availability status of each worker profile of the plurality of worker profiles. The one task in the task queue may be assignable only to workers available to receive the one task. The one worker may become unavailable to receive further tasks after receiving the one task.

The system may further include a worker location module for obtaining a geographic location of the worker associated with the worker profile.

The worker assignment module may be configured to disable at least one task type of the subset of task types of the worker profile associated with the worker whereby tasks of the at least one disabled task type are unassignable to the one worker as the one task from the task queue.

The one worker may self-assign the one task via the worker assignment module. Assignment of the one task to the one worker may be automatic upon completion of a previously assigned task.

The system may further include a task urgency module for associating an adjustable urgency weighting to each task type of the plurality of task types. The task urgency module may be in data communication with the task queue module where the task queue module sorts the plurality of tasks into the task queue further based on the adjustable urgency weighting associated with each task type is further based on the adjustable urgency weighting.

The task type prioritization module may further prioritize each task type of the plurality of task types relative to one another based on metadata. The metadata may include a status of a prerequisite task or a number of tasks in the task queue.

Each worker profile of the plurality of worker profiles may further include a worker skill weighting associated with each task type of the subset of task types in the worker profile. The worker assignment module may prioritize for assignment of the one task one worker among a plurality of workers where the one worker has a corresponding worker profile where the subset of task types includes a task type corresponding with the task type of the one task and a worker skill weighting associated therewith that is higher than the worker skill weighting associated with the same task type in any of the subset of task types of other worker profiles among the plurality of workers.

The system may further include a manager module in data communication with and configured for enabling a manager to make manual adjustments in at least one of the task type prioritization module, the worker assignment module, the task queue module and the worker profile module.

In one aspect, the system may further include a feedback module for directing the one task to a worker other than the one worker for review of the one task after completion of the one task for providing feedback on the performance thereof. The feedback module may be configured for directing the one task to the one worker after feedback is provided for acknowledgement of the feedback.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a system according to one aspect;

FIG. 2 illustrates a management application according to one aspect;

FIG. 3 illustrates a method according to one aspect;

FIG. 4 illustrates a task queue in accordance with one aspect;

FIG. 5 illustrates a manager dashboard in accordance with one aspect;

FIG. 6 illustrates a tasks view of manager dashboard in accordance with one aspect;

FIG. 7 illustrates a worker view of manager dashboard in accordance with one aspect;

FIG. 8 illustrates a “My Dashboard” view of manager dashboard in accordance with one aspect;

FIG. 9 illustrates a client view of manager dashboard in accordance with one aspect;

FIG. 10 illustrates a location view of manager dashboard in accordance with one aspect;

FIG. 11 illustrates a schedule view of manager dashboard in accordance with one aspect;

FIG. 12 illustrates a task type view of manager dashboard in accordance with one aspect;

FIG. 13 illustrates a statistics view of manager dashboard in accordance with one aspect;

FIG. 14 illustrates feedback in accordance with one aspect; and,

FIG. 15 illustrates an interface for leaving feedback in accordance with one aspect.

### DETAILED DESCRIPTION

The present disclosure generally relates to automated workflow management systems. More particularly, the present disclosure relates to methods and systems, including computer-implemented methods and systems for distributing tasks among workers in an organization.

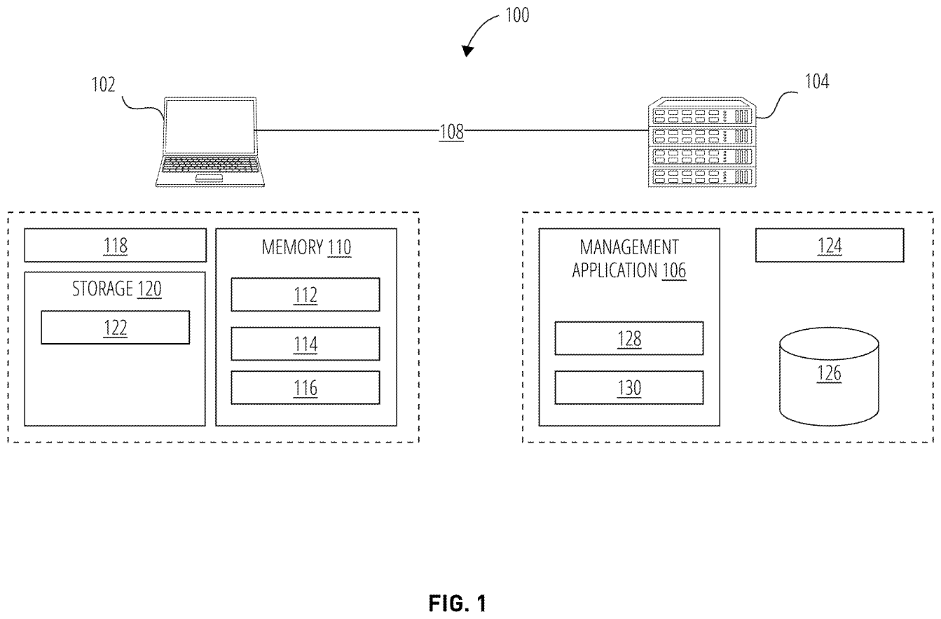

With reference to FIG. 1, there is provided a system 100 for implementing task assignment among workers within an organization according to one aspect. In one aspect, system 100 is a computerized system for automated, real-time, and dynamic load balancing of tasks among workers.

“Organization” refers to a structured group of workers, including at least one worker, who work together in pursuit of one or more common goals. This includes distribution or allocation of tasks or duties to workers or teams of workers and fulfillment of those tasks or duties for the functioning and success of the organization. In one aspect, the organization may be a business or commercial entity, a non-profit organization, a charitable organization, a sole proprietorship or other endeavor where completion of tasks by workers or groups of workers occurs. The present disclosure uses the term “organization” within the context of a business entity. It should be understood that the term “organization” may encompass other entity types.

“Worker” refers to an individual or team who is responsible for performing tasks assigned to them within the system. This term represents the element in the workflow management process, where individuals or groups are assigned jobs or tasks by the management system, based on at least one of task type priority, adjustable assignment weighting, adjustable urgency weighting, availability and other factors as described in further detail herein. Workers are typically individuals. However, there may be instances where a group or team is assigned to work on a task. One example of this is for training or education purposes where a first worker is assigned a task and a second worker is assigned the same task, but to operate as a supervisor of the first worker in their completion of the task. In some instances, a worker may also be a supervisor or a manager where a task is directed to them for completion, review or for providing feedback. Workers are also typically human. However, there may be instances where a worker is an automated worker such as a robot or virtual machine configured for having tasks assigned thereto for completion. Workers may include managers, professionals, support staff, machine workers or any other person or machine to which tasks may be assigned.

“Task” refers to a discrete unit of work or a specific activity to be performed by a worker. A single task may be a standalone work item or may be defined and organized within a workflow to accomplish a component of a more complex process or project. By breaking down complex processes or projects into smaller, manageable pieces, workflow can be distributed among workers for more efficient use of resources and streamlined progress towards an overall goal.

System 100 includes at least one client computer 102 in data communication with a server system 104. Preferably, such communication is bi-directional. Also, it should be understood that system 100 may include more than one client computer 102. Server system 104 may be co-located with client computer 102 or may be remotely located from client computer 102. In an aspect wherein client computer 102 includes a plurality of computers, it should be understood that computers may be co-located with one another or remotely located with one another or with the server system 104. Accordingly, client computer 102 and server system 104 may be components of a dispersed remote working system.

Client computer 102 communicates with server system 104 via at least one communication link 108 with the server system 104. This configuration is one non-limiting example among potential aspects. Any of several suitable communication links 108 are available, such as one or a combination of wireless, LAN, WLAN, ISDN, X.25, DSL, and ATM type networks, for example. Communication links 108 may be secured such as by encrypting data exchanged via communication links 108, encrypting communication links 108 themselves or by other suitable encryption technique. Each client computer 102 includes hardware and software including, memory 110, an operating system 112, application programs 114, a graphical user interface 116 (GUI), at least one processor 118, and storage 120 which may contain information or data 122.

In one aspect, the server system 104 may be in data exchange communication with a database 124 and data repository 126. Server system 104 has a management application 106 stored thereon and the operating system 112 is suitable for use therewith. Management application 106 is preferably a cloud-based software as a service (SaaS) application accessible over the internet via a suitable browser. However, management applications 106 instead may be downloadable software which may be stored on a client computer 102 wherein data may be exchanged between client computer 102 and server system 104 over a suitable local network. Management application 106 or its related components receive inputs from a graphical user interface 116 (GUI) of client computer 102 which provides an efficient means for users to enter and access data and to perform functions using system 100. Management application 106 includes task and worker management routines which may be called upon by the components of Management application 106 for creating, monitoring, editing and managing task and worker information and data as is described further hereinafter.

The management application 106 may be directed to a workforce, including managers and workers and may be used for prioritizing tasks to be performed and managing distribution of tasks among workers. Management application 106 may provide users, including managers and workers, with real-time functionality that includes current views and perspectives on task assignments, task urgency, business priorities, worker status, worker availability, worker skills and qualifications, worker training, feedback and reporting.

Management application 106 operates on the server system 104 in data exchange communication with database 124 and data repository 126. The management application 106 may be manipulated using a suitable graphical user interface 128 and may be accessible via a user portal 130. Data repository 126 may store data 122 related to the employees or workers in an organization, task information or any other suitable information. A manager or supervisor may also have read or write access to data repository and may input additional employee, worker or task information thereto. Such information may include past experience of an employee or worker, professional credentials of an employee, a primary, secondary, or tertiary role assigned to an employee in the organization, real-time availability of a worker including vacation dates, continuing education courses, meetings, and available hours.

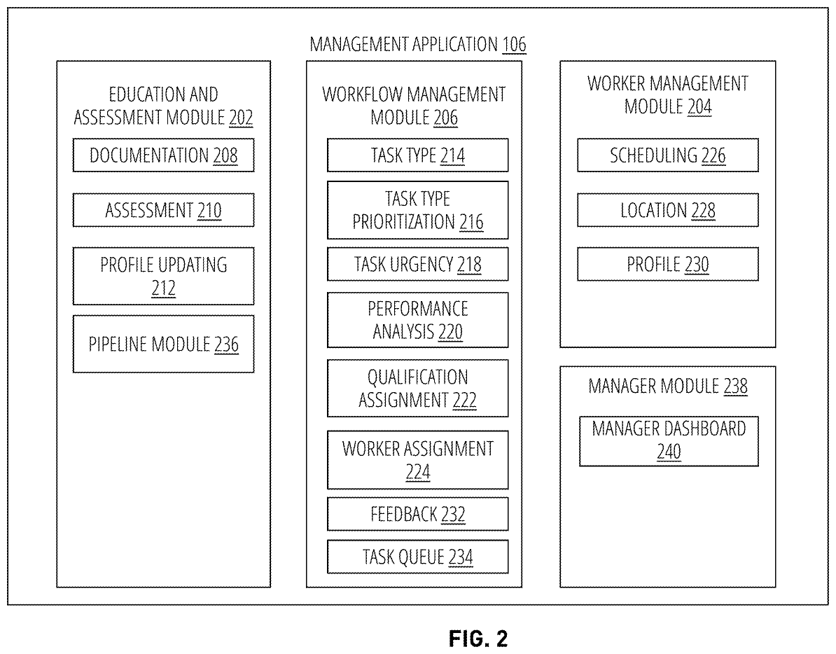

Management application 106 is further illustrated with reference to FIG. 2. Management application 106 is adapted to read and write task and worker-related data and records to database 124 and includes a worker management module 204, an education and assessment module 202, and a workflow management module 206.

Workflow management module 206 is adapted to identify, receive, prioritize and queue tasks to be performed by at least one worker in the organization, to identify a task type for each task, to identify workers to perform the tasks, to assign the tasks to the workers and to receive feedback from managers and workers. Workflow management module 206 includes task type module 214 for assignment of a task type to individual tasks, task type prioritization module 216 for assignment of a task type priority to individual task types, task urgency module 218 for assignment of an adjustable urgency weighting to individual task types, performance analysis module 220 for tracking statistics related to tasks, worker assignment and other metrics, qualification assignment module 222 for assignment of requisite qualifications to individual task types, worker assignment module 224 for facilitating assignment of tasks to workers, feedback module 232 which provides a means for a worker to provide feedback on tasks, and task queue module 234 for queueing individual tasks for assignment to workers based on assigned task type priority.

“Task type” refers to a general classification or categorization of tasks that share similar characteristics, objectives, or requirements. Task types define a template or a blueprint for a group of related tasks, outlining the common attributes and often specifying the required skills, resources, or steps needed to complete them. Task types help streamline the process of creating and managing tasks within the workflow management system by providing a reusable structure and enabling efficient allocation of resources based on the type of work.

While a task represents a discrete instance of work to be performed by a worker, a task type is a broader classification that groups together tasks along some criteria, providing a framework for creating and managing related tasks within the workflow management system.

Worker management module 204 is configured to identify information related to workers so that tasks may be efficiently allocated thereto. Worker-related information may include information contained in a worker profile of a worker, worker availability, worker skill or qualification or worker location, among other criteria. “Worker profile” refers to a comprehensive representation of an individual worker's attributes, skills, and characteristics within the system. The worker profile serves as a basis for effectively assigning tasks, tracking performance, and managing resources within the organization. It facilitates informed decision making by the system for assignment of tasks to appropriate workers. Worker management module 204 includes worker scheduling module 226 for determining worker availability, worker location module 228 for determining worker location and worker profile module 230 which provides access to worker profiles of individual workers which may contain any of the above information along with other information related to the individual workers belonging to each profile. Worker management module 204 may be coupled in data communication with scheduling software used by the organization from which scheduling, location or other information may be retrieved with respect to one or more workers. Elements of the worker management module 204 may cooperate to meet certain criteria. For example, the worker location module 228 and the worker profile module 230 may cooperate to ensure that workers meeting certain required criteria are available at a location. For example, if each office in an organization requires a worker with certification or authorization to operate within a role of Supervisor, then these modules may cooperate to ensure that requirement is met.

Education and assessment module 202 is adapted to provide workers and managers with access to documentation, guidance, training materials, education, standards, compliance, regulatory and other materials and information to assist in the performance of work-related tasks and to assist in worker development. Worker training and education may be tracked and reported via this module. Moreover, once a worker completes training or education, education and assessment module 202 may update the qualifications of the worker in the associated worker profile. Education and assessment module 202 includes documentation module 208 for providing access to technical documents, procedural documents, training materials and any other documentation related to procedures or training related to tasks or task types, assessment module 210 for assessment of worker training and worker performance associated with tasks and worker profile updating module 212 for allowing updates to be made to worker profiles based on completed training or experience acquired with respect to certain task types or tasks. The education and assessment module 202 also maintains a record of formal training for individual workers, such as professional certifications, that may be required for certain tasks. This allows for specific task types that can only be performed by qualified workers to be allocated to only those workers. Moreover, education and assessment module 202 may further include pipeline module 236 for housing documentation and assessment pipelines or predetermined learning paths to facilitate worker training and qualification.

Workflow management module 206 further includes manager module 238 which contains manager dashboard 240 for allowing a manager to access various information related to tasks, task types, worker profiles and to determine and adjust adjustable assignment weighting, adjustable urgency weighting, subsets of task types associated with worker profiles or any other information or criteria related to the system 100. Manager module 238 is described in further detail hereinafter.

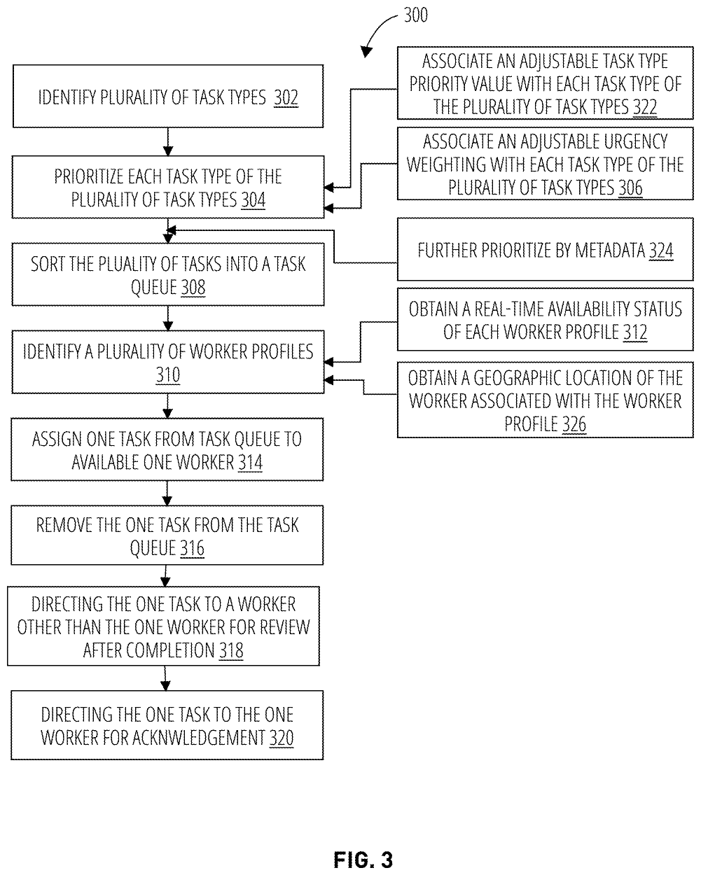

FIG. 3 illustrates a flowchart diagram of a method 300 for assigning a task to a worker in an organization, implemented by computer, according to one aspect.

In a first block 302, a plurality of task types within which each task of a plurality of tasks is classifiable are identified.

Next, at block 304, each task type of the plurality of task types is prioritized relative to one another. Prioritization may be based on any desired criteria. In the aspect described herein, task type prioritization is facilitated by the task type prioritization module 216 of workflow management module 206. Prioritizing the task types may be done, for example, by associating an adjustable task type priority value with each task type, as shown at block 322. Association of the adjustable task type priority value may be done by a manager or other person or persons in charge of overseeing workflow within a team or an organization. In one aspect, an adjustable task type priority value may be assigned on a scale from 0 to 100 with an adjustable task type priority value of 0 being assigned to a task type with a lowest priority and an adjustable task type priority value of 100 being assigned to a task type with a highest priority. As business objectives within an organization may change over time, prioritization of each task type may be adjusted by adjusting the adjustable task type priority value associated with different task types to meet demands on operations of the organization. Accordingly, prioritization of task types is dynamic and may be subject to change over time.

In one aspect, the task urgency module 218 may identify an adjustable urgency weighting for each task type. The adjustable urgency weighting may be associated with each task type of the plurality of task types, as shown at block 306. In one aspect, the adjustable urgency weighting may be assigned on a scale from 0 to 100 with an adjustable urgency weighting of 0 being assigned to a task type with a lowest urgency and an adjustable urgency weighting of 100 being assigned to a task type with a highest urgency. As with assignment of a task type priority value, urgency associated with task types may be subject to change over time. Accordingly, prioritization of task types based on urgency is also a dynamic process. Moreover, prioritization may be along a single dimension, such as the task type priority value only, or along multiple dimensions, such as the adjustable task type priority value and adjustable urgency weighting together. In an aspect wherein both a task type priority value and an adjustable urgency weighting are associated with each task type, both the task type priority value and the adjustable urgency weighting may be taken into account in prioritizing task types.

At block 308, the plurality of tasks is sorted into a task queue according to relative priority of the task type with which each task of the plurality of tasks is associated. The method of sorting the plurality of tasks into task queues may be manually or automatically adjustable in order to minimize various factors (such as queue size) or maximize other factors. The task queue may be further prioritized by metadata such as a status of a prerequisite task or a number of tasks in the task queue, or task queue length or other suitable metadata as shown in block 324.

At block 310, a plurality of worker profiles is identified. Each worker profile has a subset of task types assignable to a worker associated with the worker profile and an adjustable assignment weighting for each task type of the subset of task types. The subset of task types assignable to the worker contained within the worker profile may be determined based on any suitable criteria. For example, a worker may have past experience performing a particular task type or may have received formal education or training with respect to a particular task type. The worker profile also contains worker qualifications and certifications. If a particular task type has a requisite qualification or certification for performance of that task, then worker having corresponding qualifications in their worker profile are more likely to be assigned those particular tasks. Accordingly, worker skillset may affect the subset of task types associated with the worker profile. The subset of task types associated with the worker profile may be affected by other criteria such as scheduling, worker location, availability or manual assignment of task types thereto by a manager. In one aspect, identification of the plurality of worker profiles further includes obtaining a real-time availability status of each worker profile of the plurality of worker profiles, as shown at block 312. In one aspect, the one task in the task queue is assignable only to workers available to receive the one task. The one worker may become unavailable to receive further tasks after receiving the one task. In one aspect, identification of the plurality of worker profiles further includes obtaining a geographic location of the worker associated with the worker profile, as shown at block 326.

System 100 may further include documentation and assessment pipelines for each assignable task in the organization. In the aspect described herein, the documentation and assessment pipelines are contained within pipeline module 236 of education and assessment module 202 and are created based on resources contained within the documentation module 208 and the assessment module 210. The documentation and assessment pipeline therefore provides access to resources and learning paths contained within the documentation module 208 and the assessment module 210 for allowing workers to achieve competency in performing certain tasks or task types. The documentation and assessment pipeline can include task information such as the nature of the work, applicable deadlines, priority of the work to the business operations, qualifications or expertise relied upon to perform the task, and so on. If a task type relies on workers having specific qualifications, the workers can be identified as qualified to perform a task when they achieve competency in the task. Based on the documentation and assessment pipeline, a list of workers that meet the criteria to perform the task may receive higher priority for receiving the assignment of tasks or task types related to their achieved competency level. In order to reflect competency or experience of a worker in performing a particular task type, the worker profile may include a worker skill weighting representative of a level of skill or competency that the worker has in performing one or more task types of the subset of task types assigned in their profile. The worker skill weighting may be partially based on performance metrics defined in the documentation and assessment pipeline.

In another aspect, prioritization of one or more task types among the subset of task types for a worker profile can be determined based on a primary role of the worker within the organization wherein the worker would be expected to perform a subset of task types congruent with that primary role. The task types associated with the primary role may be set to a higher level of priority in the worker profile relative to other task types among the subset of task types. In another aspect, a worker may have one or more secondary roles in addition to the primary role assigned to the worker and may be assigned task types congruent with the one or more secondary roles. Task types associated with secondary roles may be assigned a lower priority in the worker profile relative to task types associated with the primary role. However, it should be understood that the priority setting for task types within the subset of task types in a worker profile is not bound to the role of the worker in the organization or the experience of skillset of the worker. Rather, the priority settings associated with task types within the worker profile may change depending on business priorities, staffing, and priority values assigned to a task type at any given time. For example, task types which are typically set at secondary or tertiary importance in a worker profile of a worker may be adjusted to a highest level of priority. This would result in the worker focusing on task types which may not be in full agreement with the primary role of the worker within the organization. Likewise, a manager may assign a new task type to the profile of a worker and may give that task type a highest level of priority. Accordingly, workers may be assigned to new task types which are outside of their usual role in the organization and with which the worker skill weighting would be low. Tasks of that task type to work on at a highest level of priority.

In another aspect, a subset of tasks in a worker profile may include a task of a task type with which the worker has little or no experience and is undergoing training to perform tasks of that task type. Such an assignment may be made by a manager of the worker in question, for example. A manager is also free to arbitrarily assign a task type to a worker profile, thereby adding that task type to the subset of task types identified as performable by the worker in the worker profile.

In another aspect, the subset of tasks performable by a worker may be determined, at least in part, by worker availability. The worker profile may include an availability status of the worker. Preferably, the availability status of a worker is displayed in real-time or near real-time. Availability of a worker may be affected by worker schedule. Hence, other tasks assigned to the worker, meetings, travel, leave or vacation time scheduled may affect availability of a worker. In one aspect, the real-time availability status of a worker can be displayed by one of “online”, “offline”, or “busy”. In one aspect, the workers who are unavailable for work (“offline” or “busy”) are omitted from the list of workers available for assignment of a next task. Accordingly, in one aspect, tasks are unassignable to workers who are not available. For certain tasks which are to be performed at a specific location, the availability status of the worker presented in the worker profile can also include geographical location information. This criterion may be used, for example, where a task type is linked to a specific geographic location or where only one or a small number of workers is available at a particular location to perform a task. A manager or supervisor may also review the real-time availability assessment of a worker and execute a prioritization manually or otherwise to exercise discretion in assignment of tasks.

System 100 intertwines worker resource demands and availability with task demands and availability. That is, a manager or human resources department can directly use a projection of task demands or a known backlog of tasks to identify or project human resource requirements and shortfalls. The manager or human resources department can then assign or reallocate task priorities to workers accordingly in order to meet task demands.

At block 314, one task from the task queue is assigned to one worker. The one task corresponds with at least one task type of the subset of task types of the worker profile associated with the one worker. The one task is prioritized for assignment relative to other tasks in the task queue according to relative priority of the task type with which the one task is associated. The task type of the one task is weighted according to the adjustable assignment weighting associated with the at least one task type of the subset of task types.

At block 316, according to one aspect, the one task is removed from the task queue after assignment to the one worker.

Assigning the one task to the one worker may be automatic upon completion of a previously assigned task. In another aspect, the one task may be self-assigned to the one worker. In one aspect, the one worker may interact with the management application 106 to prompt for assignment of a next task such as, for example, by interacting with a virtual “next task” button or hyperlink to trigger assignment of a next task. Other means for self-assignment may be relied upon. The next task that is self-assigned may be from among one particular task type of the subset of task types or may be from among all task types of the subset of task types. Thereby, a worker may focus on completing tasks of particular task types or may choose a next available task from all task types in order to continue completing tasks in the order they are provided by the task queue. Moreover, it should be understood that in one aspect, a worker is able to select tasks which are of task types having a lower adjustable task type priority value even though there may be task types having a higher adjustable task type priority value associated therewith available for selection. Accordingly, in one aspect, the one worker may have flexibility in addressing tasks which are assigned to them from the tasks queue.

At block 318, there is shown one aspect wherein the one task is directed to a worker other than the one worker for review of the one task after completion of the one task for providing feedback on the performance thereof. As shown at block 320, the one task may then be directed to the one worker after feedback is provided for acknowledgement of the feedback.

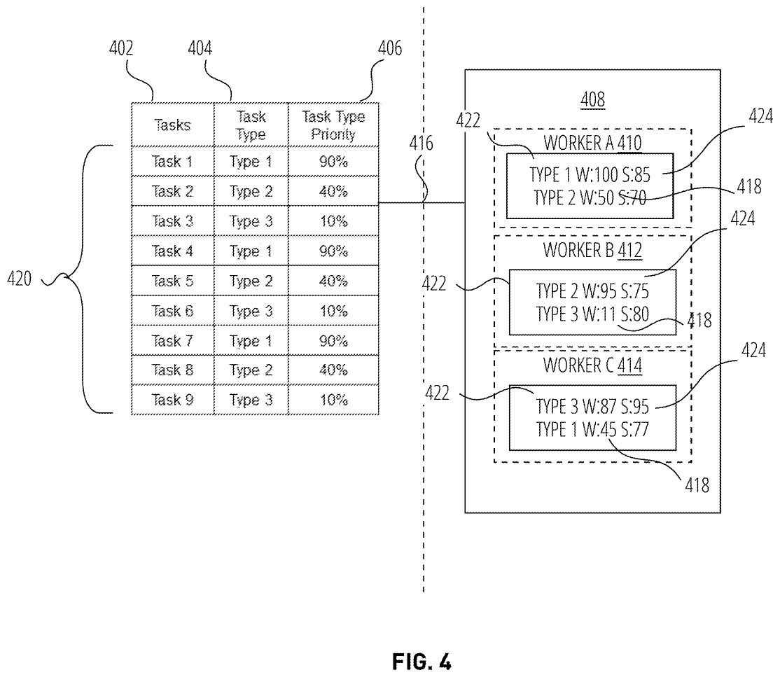

FIG. 4 illustrates prioritization of the task types of the plurality of task types relative to one another and the association of the prioritized task types with the subset of task types identified in a worker profile as performable by the worker associated with the worker profile, according to one aspect.

In FIG. 4, there is shown a set of nine tasks 420 arranged into task queue 402. The nine tasks represented in task queue 402 are illustrative of the body of tasks to be performed or completed by an organization. It should be understood that the number of tasks may be greater or fewer than nine and that any number of tasks may be arranged to form task queue 402. Each task in task queue 402 is assigned a task type 404. For illustrative purposes, the nine tasks in task queue have each been assigned one of three task types 404. It should be understood that the tasks in task queue may be classified into any number of task types 404. However, the number of task types 404 may not exceed the number of tasks. Each task type 404 is assigned an adjustable task type priority value 406. Preferably, assignment of the adjustable task type priority value 406 to task types 404 is done by a manager, executive or other decision-maker in the organization responsible for configuring the order of tasks to be performed. The system 100 uses the adjustable task type priority value 406 for each task type 404 to order tasks to be performed relative to one another by task type priority. Thereby, the adjustable task type priority value 406 is used by the system 100 to order the tasks to be performed by the organization into task queue 402. The adjustable task type priority value 406 for any task type 404 may be adjusted over time and therefore, the order in which tasks appear in the task queue 402 may also change over time.

In the aspect shown in FIG. 4, adjustable task type priority value 406 is expressed as a percentage ranging between 0% and 100% with a higher percentage value being representative of a higher priority task type relative to other task types 404. In the illustrative example shown in FIG. 4, Type 1 tasks are given adjustable task type priority value 406 of 90%, Type 2 tasks are given an adjustable task type priority value 406 of 40% and Type 3 tasks are given an adjustable task type priority value 406 of 10%. Since the Type 1 tasks have the highest adjustable task type priority value 406, Type 1 tasks appearing in task queue will be assigned to workers for completion earlier or in greater proportion relative to the Type 2 and Type 3 tasks. Type 2 tasks will be assigned to workers for completion later or at a lower proportion than Type 1 tasks and earlier or at a higher proportion than Type 3 tasks. Type 3 tasks will be assigned to workers for completion latest or at the lowest proportion. However, as further described hereinbelow, tasks of a specific task type 404 are preferably assigned to workers having the corresponding task type 404 in their worker profile 408. Therefore, not all workers are necessarily available to perform the highest priority task types 404, such as Type 1 tasks in the example of FIG. 4. An exception to this would be an instance wherein all worker profiles 408 include a specific task type 404 within the subsets of task types 422.

It should be understood that it is not required that the percentage values associated with the range of task types 404 in FIG. 4 add up to 100%. Rather, the percentage values represent a priority of the task type relative to one another. Accordingly, the relative priority between task types may be represented in another suitable manner that is not a percentage value, such as a whole number, a color scheme, or a graphical representation such as a bar or slider.

Further illustrated in FIG. 4 are three worker profiles 408 including Worker A profile 410, Worker B profile 412, and Worker C profile 414. As previously described, each worker profile 408 includes a subset of task types 422. In the aspect of FIG. 4, the task type of a task from the task queue 402 being assigned to a worker corresponds with at least one task type of the subset of task types of the worker profile associated with that worker. Each task type among the subset of task types 422 has an adjustable assignment weighting 418 associated therewith. The task type of the task being assigned to the worker is weighted according to the adjustable assignment weighting 418 associated with the task types 404 of the subset of task types 422 in the worker profile 408. Tasks having task types 404 with a relatively higher adjustable assignment weighting 418 in the subset of task types 422 are relatively more likely to be assigned to the worker as compared to tasks of other task types 404. Tasks having task types 404 with a relatively lower adjustable assignment weighting 418 in the subset of task types 422 are relatively less likely to be assigned to the worker as compared to tasks of other task types 404. Accordingly, where the adjustable task type priority value 406 prioritizes tasks for sorting into task queue 402, the adjustable assignment weighting 418 provides a means for system 100 to direct the assignment of tasks from the task queue to the appropriate worker. System 100 is therefore highly adaptable to shifting needs of the organization. The adjustable task type priority value 406 for different task types 404 is adjustable to allow reordering of the task queue 402 based on changing organizational priorities. The subset of task types 422 in the worker profile 408 provides a means for directing tasks to the appropriate or desired workers for completion of those tasks. As described above, the subset of task types is adjustable to allow redirection of tasks to other works as needed. The adjustable assignment weightings for task types in the subset of task types provides weighting to direct tasks of certain task types in desired proportions for each task type.

It should be understood that it is not required that the percentage values associated with the range of adjustable assignment weightings 418 in FIG. 4 add up to 100%. Rather, the percentage values represent a weighting associated with each task type relative to one another. Accordingly, the relative weighting between task types in each subset of task types may be represented in another suitable manner that is not a percentage value, such as a whole number, a color scheme, or a graphical representation such as a bar or slider.

As shown in the illustrative example of FIG. 4, the subset of task types 422 for Worker A profile 410 includes Type 1 tasks and Type 2 tasks wherein the Type 1 tasks have associated adjustable assignment weighting 418 of 100% and the Type 2 tasks have associated adjustable assignment weighting 418 of 50%. The adjustable assignment weighting 418 in a worker profile may be identified by any suitable means. In the aspect illustrated in FIG. 4, the adjustable assignment weighting 418 of Worker A profile 410 are represented by the notation “W: 100” for the Type 1 tasks and “W: 50” for the Type 2 tasks, wherein the letter “W” stands for “Weight”. Similar notation is used to represent the adjustable assignment weighting 418 in Worker B profile 412 and Worker C profile 414. Accordingly, the worker associated with Worker A profile 410 will be the primary focus for assignment of Type 1 tasks, such as Task 1, Task 4 and Task 7 in task queue 402. In circumstances where all Type 1 tasks have been completed or are being worked on by another worker (such as the worker associated with Worker C profile 414), the worker associated with Worker A profile 410 may be assigned a Type 2 task, such as Task 2, Task 5 and Task 8 in task queue 402, if one is available for assignment from task queue. The subset of task types 422 for Worker B profile 412 includes Type 2 tasks and Type 3 tasks wherein the Type 2 tasks have associated adjustable assignment weighting 418 of 95% and the Type 3 tasks have associated adjustable assignment weighting 418 of 11%. Therefore, the worker associated with Worker B profile 412 will be the primary focus for assignment of Type 2 tasks, while being available for assignment of Type 3 tasks on a lower-priority basis if a Type 3 task is available from task queue. Likewise subset of task types 422 for Worker C profile 414 includes Type 3 tasks and Type 1 tasks wherein the Type 3 tasks have associated adjustable assignment weighting 418 of 87% and the Type 1 tasks have associated adjustable assignment weighting 418 of 45%. Therefore, the worker associated with Worker C profile 414 will be the primary focus for assignment of Type 3 tasks, such as Task 3, Task 6 and Task 9 in task queue 402, while being available for assignment of Type 1 tasks on a lower-priority basis if a Type 1 task is available from task queue 402. It should be understood that while there is shown two adjustable assignment weighting 418 for each worker in FIG. 4, there could be more or less than two. Further, the number of task types 404 assigned to each worker profile 408 may differ.

In one aspect, each task type among the subset of task types 422 may also have a worker skill weighting 424 associated therewith. Worker skill weighting 424 provides an indication of the level of skill that a worker associated with the worker profile has in association with tasks of the task type associated with the worker skill weighting 424. Worker skill weighting 424 may be based on past experience with specific task types 404, competence, training, worker skill with a particular task type, adjustment by a manager or other criteria described herein.

The worker skill weighting 424 may be used in conjunction with the adjustable assignment weighting 418 for assignment of tasks having task types corresponding with task types of the subset of task types found in the worker profile. Further weighting assignment of tasks based on the worker skill weighting 424 allows for tasks to be assigned to workers having a desired level of experience or skill for working with the associated task type. One advantage is that tasks may be directed to one worker among a plurality of workers wherein the one worker has a corresponding worker profile wherein the subset of task types includes a task type corresponding with the task type of the task being assigned and a worker skill weighting associated therewith that is higher than the worker skill weighting associated with the same task type in any of the subset of task types of other worker profiles among the plurality of workers. Thereby, the task may be directed to the most highly skilled available worker having a corresponding task type in their worker profile. Another advantage is that tasks may be directed to workers having limited experience or competence dealing with a certain task type and therefore a relatively lower worker skill weighting 424 associated with that task type. This may be suitable to identify task types for which the worker requires training. For example, a manager may manually adjust the adjustable assignment weighting 418 for that less-familiar task type in the worker profiles 408 to a higher setting so that the assignment and completion of the less-familiar tasks by the worker would be given higher priority. In this manner, workers who are highly skilled for one or more certain task types 404 may be directed to focus on other task types 404. One other advantage of the worker skill weighting 424 is that it may act as a “tie breaker” where the system 100 is unable to distribute a task effectively between one worker or another based on the adjustable assignment weighting 418 alone.

It should be understood that it is not required that the percentage values associated with the range of worker skill weightings 424 in FIG. 4 add up to 100%. Rather, the percentage values represent a weighting associated with each task type relative to one another. Accordingly, the relative weighting between task types in each subset of task types may be represented in another suitable manner that is not a percentage value, such as a whole number, a color scheme, or a graphical representation such as a bar or slider.

As shown in the illustrative example of FIG. 4, the subset of task types 422 for Worker A profile 410 includes Type 1 tasks and Type 2 tasks wherein the Type 1 tasks have associated worker skill weighting 424 of 85% and the Type 2 tasks have associated worker skill weighting 424 of 70%. The worker skill weighting 424 in a worker profile may be identified by any suitable means. In the aspect illustrated in FIG. 4, the worker skill weighting 424 of Worker A profile 410 are represented by the notation “S:85” for the Type 1 tasks and “S:70” for the Type 2 tasks, wherein the letter “S” stands for “Skill”. Similar notation is used to represent the worker skill weighting 424 in Worker B profile 412 and Worker C profile 414. The subset of task types 422 for Worker B profile 412 includes Type 2 tasks and Type 3 tasks wherein the Type 2 tasks have associated worker skill weighting 424 of 75% and the Type 3 tasks have associated worker skill weighting 424 of 80%. The subset of task types 422 for Worker C profile 414 includes Type 3 tasks and Type 1 tasks wherein the Type 3 tasks have associated worker skill weighting 424 of 95% and the Type 1 tasks have associated worker skill weighting 424 of 77%. Accordingly, in the aspect of FIG. 4 wherein the subset of task types 422 includes worker skill weighting 424, the worker associated with Worker A profile 410 will be assigned Type 1 tasks ahead of the worker associated with Worker C profile 414 because the worker skill weighting 424 of the worker associated with Worker A profile 410 is higher. Likewise, the worker associated with Worker B profile 412 will be assigned tasks of Type 2 ahead of the worker associated with Worker A profile 410 and the worker associated with the Worker C profile 414 will be assigned Type 3 tasks ahead of the worker associated with Worker B profile 412 again because the worker skill weighting 424 of those workers is higher for that task type.

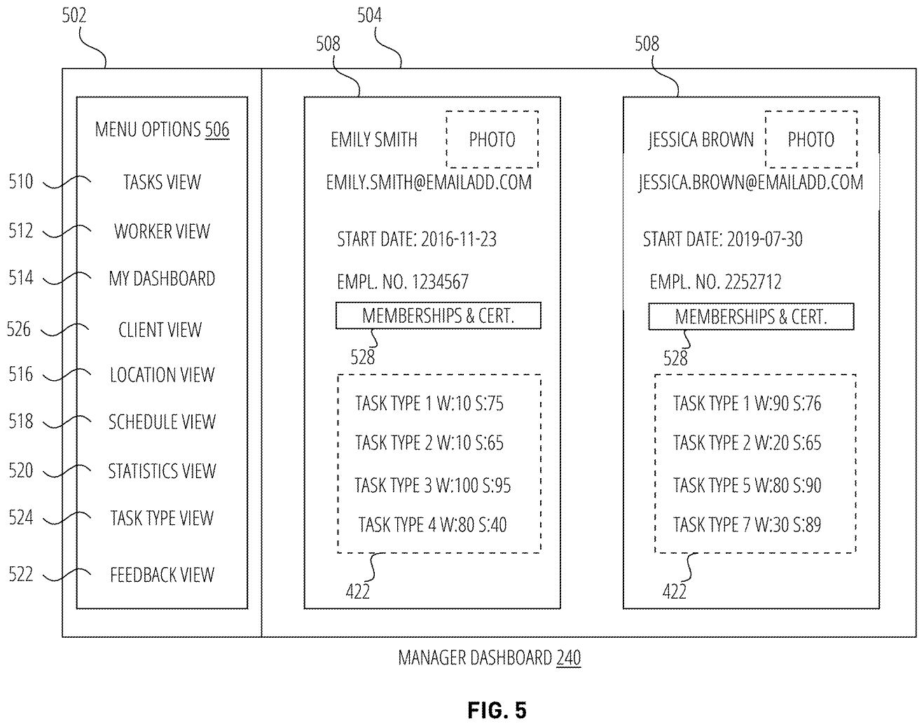

With reference to FIG. 5, there is shown manager dashboard 240, which is a component of manager module 238 of management application 106 and is used for presenting information to one or more managers (not shown) and allowing the one or more managers to determine and adjust organizational task priorities and manage worker task type priorities among other aspects of the system 100. Manager dashboard 240 may be configured or customized to present whatever information meets the needs of the organization and preferably to the needs of each individual manager. Accordingly, other configurations of manager dashboard 240 may be utilized without departing from the aspects as described herein.

In the exemplary aspect shown in FIG. 5, manager dashboard 240 is subdivided into a menu subsection 502 and a working subsection 504. Menu subsection 502 includes at least one and preferably a plurality of menu options 506, each of which provides access to a more detailed view of information on specific aspects of workflow within the organization and management thereof via the manager dashboard 240. That is, upon selection by a user or manager of one of the menu options 506 in the menu subsection 502, more detailed information specific to that menu option 506 selection is displayed in the manager dashboard 240. The information provided by each one of the menu options 506 may be accessed by interaction with the menu option 506 such as, for example, by clicking on the menu option 506. The information provided by each menu option 506 is preferably real-time information or information which can be updated on command such as, for example, by clicking on an “Update” or “Refresh” button (not shown) or by terminating and resuming the application. It should be understood that each menu option 506 of the plurality of menu options 506 may include any number of submenu options to provide more specific information related to the broader category provided by the parent menu option 506. For example, menu subsection 502 may include feedback view 522 menu option for a manager to access and view feedback provided by workers or provided by the manager to workers associated with certain tasks.

In the exemplary aspect of manager dashboard 240 shown in FIG. 5, there is displayed a list of currently available workers, identified by their worker profile cards 508, as well as the subset of task types 422 associated with each of the displayed worker profiles 408. Also displayed is the adjustable assignment weighting 418 associated with each task type 404 of the subset of task types 422 for the worker profile 408. In this aspect, each worker profile 408 is presented on a worker profile card 508, which may further include buttons or hyperlinks which allow a manager to view in more detail associated information that is presented on the 508. Each worker profile card 508 is coupled in data communication with a corresponding worker profile 408 and displays data and information from the worker profile 408. For example, worker profile card 508 may include the name of the worker, an identification number associated with the worker, contact information of the worker, an identifying image of the worker such as a photograph and the subset of task types 422 associated with the worker profile 408. Although not shown in FIG. 5, each task type 404 of the subset of task types 422 may have associated therewith an adjustable task type priority value 406 and may also have associated therewith a color indicating the task type 404 or corresponding with the associated adjustable task type priority value 406. For example, an adjustable task type priority value 406 which is very high might be indicated by displaying the task type within a green rectangle. Other colors may be selected to indicate adjustable task type priority value 406. Some or all of this information may be contained within the worker profile card. Other suitable information may also be included in the worker profile card 508 either by design or modification thereto. For example, each worker profile card 508 may include a button or hyperlink to allow a manager to view tasks which have been completed by the worker associated with the worker profile 408.

Within the worker profile 408 of each worker, a manager may also view memberships and certifications that a worker may have by choosing an option on the worker profile 408, such as memberships and certifications button 528. It should be understood that this information may be accessed using a control other than a button, such as a hyperlink or direct display within the worker profile 408, for example.

Information shown on each worker profile card 508 is adjustable. Accordingly, a manager may use the manager dashboard 240 to modify or delete the information in the worker profile card 508. A manager may also modify the adjustable assignment weighting 418 for any task type 404 listed in the worker profile card 508. Moreover, a manager may selectively enable or disable specific task types 404 from among the subset of task types directly within the worker profile card 508. When a task type 404 is enabled within the worker profile card 508, tasks of that task type 404 may be assigned to the worker of the worker profile 408. However, a task type 404 may be disabled by the manager within the worker profile 408 and the worker may not be assigned tasks of the disabled task type 404 until it is enabled once again.

Interaction with menu options 506 in menu subsection 502 allows a manager to access other information available in manager module 238. It should be further understood that menu options 506 may be added or removed from menu subsection 502 depending on the needs of the manager.

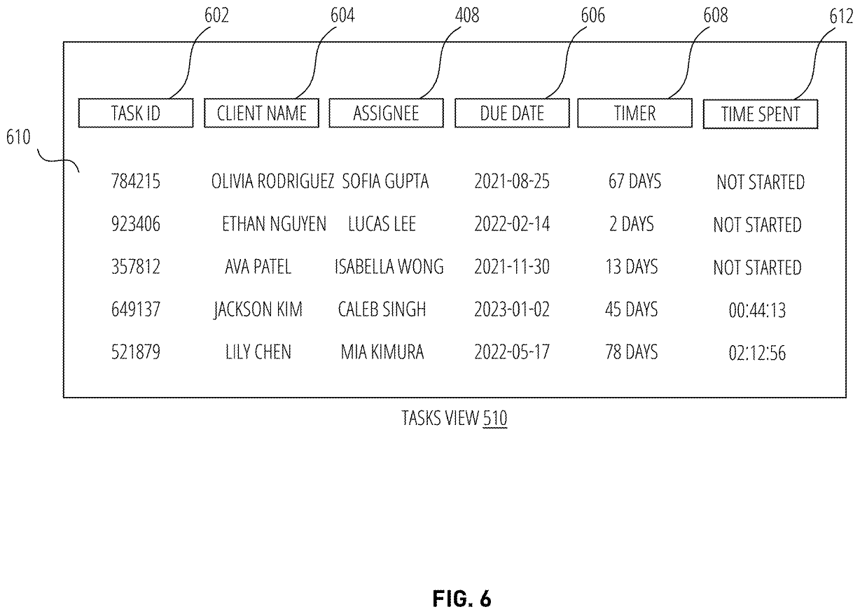

For example, menu options 506 shown in menu subsection 502 of FIG. 5 may allow a manager to access a tasks view 510 which allows the manager to view a filterable list of tasks 610 to be performed by workers in the organization, as shown in FIG. 6. The list of tasks 610 is filterable to provide visibility of a “master” task queue containing all tasks assignable within the organization or various tasks queues that have been selected based on various filtering options. Moreover, a manager may use menu options 506 or filters to access saved custom task queues or old or expired worklists as well as current or projected works lists. Each task in the list of tasks 610 is provided with a task identification number 602 as shown in the column labeled “TASK ID”. Each task identification number 602 has at least one worker profile 408 assigned thereto as shown in the “ASSIGNEE” column. The worker profile 408 may be identified, for example, by the assigned worker's first and last name which may be retrieved from the worker profile 408. Each task may also have an associated due date 606 for completion and a timer 608 which may be activated to track the pendency of the task. Some tasks in the list of tasks 610 may be filtered in order to bring them to the attention of the manager. For example, a manager may filter the list of tasks 610 to retrieve cases which are ready for the manager to review. Other tasks may be filtered or otherwise identified in the list of tasks 610 as needed in order to meet the needs of the organization, the worker or of the individual manager.

In the aspect shown in FIG. 6, there is shown a time spent column 612 which allows a manager to determine whether work has started on any of the tasks in the list of tasks 610 and/or the amount of time a worker has spent completing any of the tasks in the list of tasks 610. Time spent column 612 may display the time spent on a task in any suitable format, such as “hh:mm:ss” and may display that work on a task has not started in any suitable format, such as by displaying “Not Started” or a time entry of “00:00:00”. This is advantageous as it allows a manager to identify whether particular task types require a heavier or lighter time investment or to identify workers who may be spending an inappropriate amount of time completing tasks or a particular type. In one aspect, the amount of time spent on all tasks completed by a worker is recorded in the worker's worker profile and may be accessible by a manager for review.

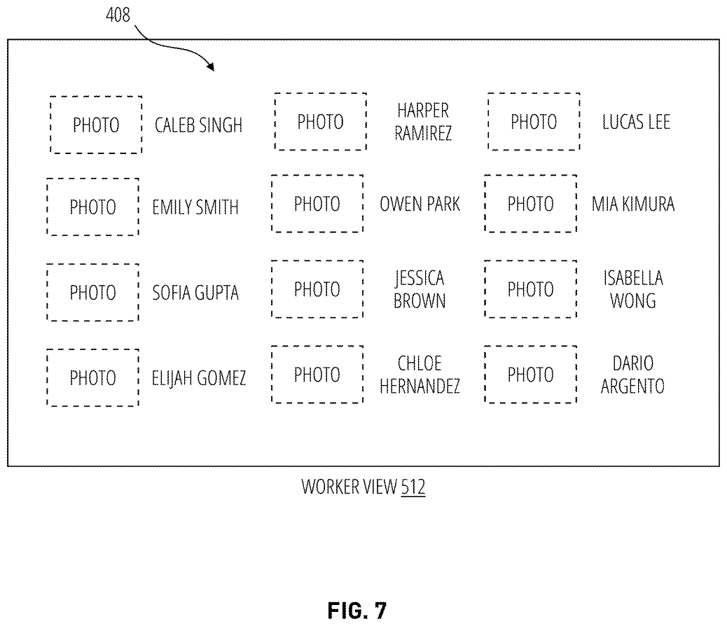

Menu subsection 502 of FIG. 5 may further include a menu option 506 such as “worker view 512” to allow a manager to view a filterable list of worker profiles 408 available within the system 100 as shown, for example in FIG. 7. Worker view 512 may be used by the manager to view any of the worker profiles 408 for selection and adjustment of the subset of task types 422 or other information related thereto. In another aspect, the manager may view worker profiles 408 which have no task types assigned thereto. This may be useful when balancing workload among multiple workers. The manager may also access tasks assigned to the workers associated with the worker profiles in the list and manually assign tasks to those workers. The manager may, for example, access task queue 402 to find a task, identify a worker whose worker profile 408 indicates that the worker can have that task assigned to them and then assign the task to that worker. In one aspect, the manually assigned task is then removed from the task queue 402 automatically by system 100.

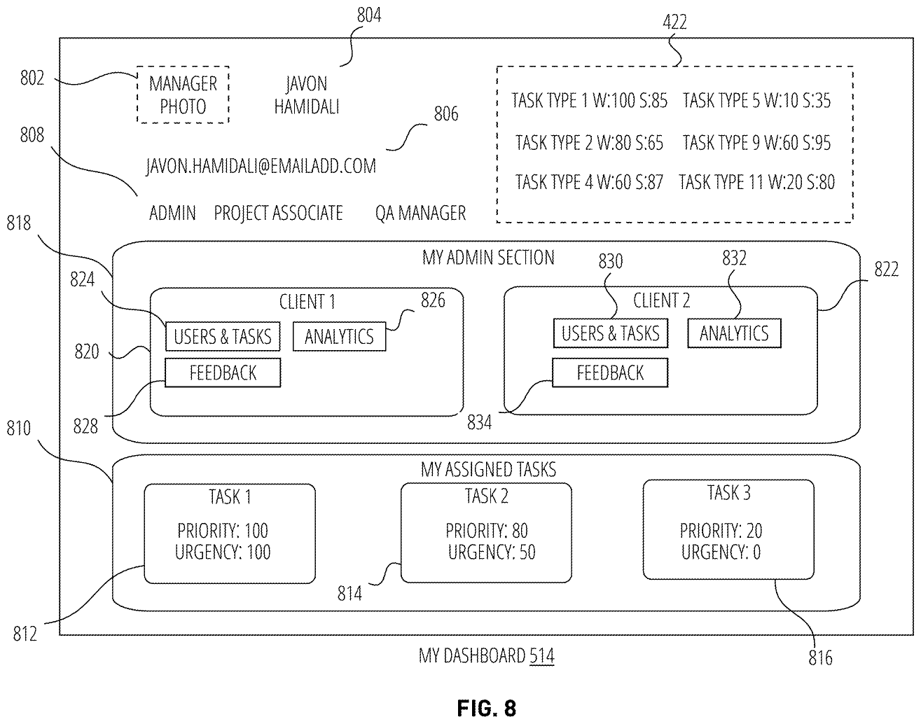

Menu subsection 502 of FIG. 5 may further include a menu option 506 such as “My Dashboard 514” for a manager to access and view a manager's own dashboard as shown in FIG. 8. As with other workers, the manager may view elements of their own profile including manager photo 802, manager name 804, manager email 806, manager roles 808, manager subset of task types 422 and manager assigned tasks 810. Elements of the manager profile may be adjusted as needed. For example, a manager may adjust the adjustable task type priority value 406 of any task types in the subset of task types 422 in their profile. Likewise, the manager may adjust any adjustable task type priority value or adjustable urgency weightings at the task level as shown, for example in Task 1 812, Task 2 814 and Task 3 816 shown in the My Dashboard 514. It should be understood that any number of tasks may be displayed or accessible from My Dashboard 514. A manager may also their manager roles 808 and any assigned tasks that they may have self-assigned or which may have been assigned to them by the system 100. The manager may view and adjust any due dates associated with specific tasks to which they have been assigned and view the timer associated therewith.

As shown in FIG. 8, My Dashboard 514 also includes manager admin section 818 wherein a manager may view client-specific information. For example, manager may view information such as a profile associated with Client 1 820. The manager may view and modify users and tasks assigned to work on matters associated with Client 1 820 by interacting with the Users & Tasks 824 button. Also, the manager may view feedback and analytics associated with Client 1 820 by interacting with Analytics 826 button or Feedback 828 button. Likewise, the manager may view and modify users and tasks assigned to work on matters associated with Client 2 822 by interacting with the Users & Tasks 830 button. The manager may view feedback and analytics associated with Client 2 822 by interacting with Analytics 832 button or Feedback 834 button.

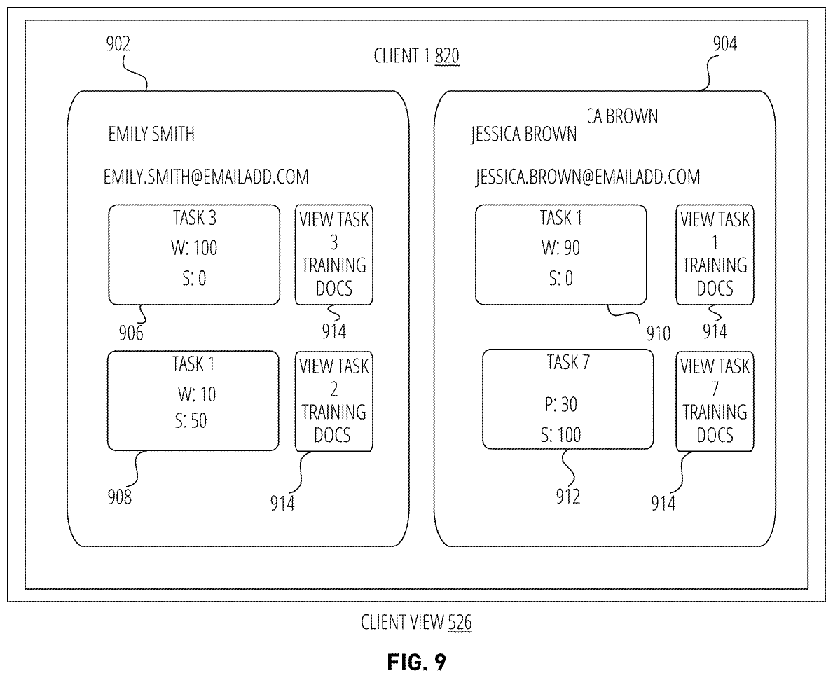

Menu subsection 502 of FIG. 5 may further include a menu option 506 for a manager to access a client view 526 for providing a manager with a view of specific user and task information associated with specific clients, as shown in FIG. 9. In the aspect illustrated in FIG. 9, workers assigned to completion of tasks for Client 1 820 include two workers: Emily Smith 902 and Jessica Brown 904. The contact information for each worker is visible. Each worker has assigned tasks, 906, 908, 910, 912 and the adjustable assignment weighting associated with the task type associated with each task is visible. In one aspect, the worker skill weighting for the task type associated with that task is also visible. Accordingly, a manager is able to view the workers and tasks assigned for particular clients using manager dashboard 240. Although only a single client, Client 1 820, is shown in the aspect illustrated in FIG. 9, it should be understood that information related to other clients may be viewed by selection of or search for a new client. In one aspect, the information related to each client is all available on a single page in client view 526 simply by scrolling up or down to view other client information. Should the manager or the worker, when viewing their assigned tasks, wish to view documentation associated with a particular task, then they may use the view task training documents button 914 which may be positioned next to each task. View task training documents button 914 retrieves information available in the education and assessment module 202 for the manager or worker to review.

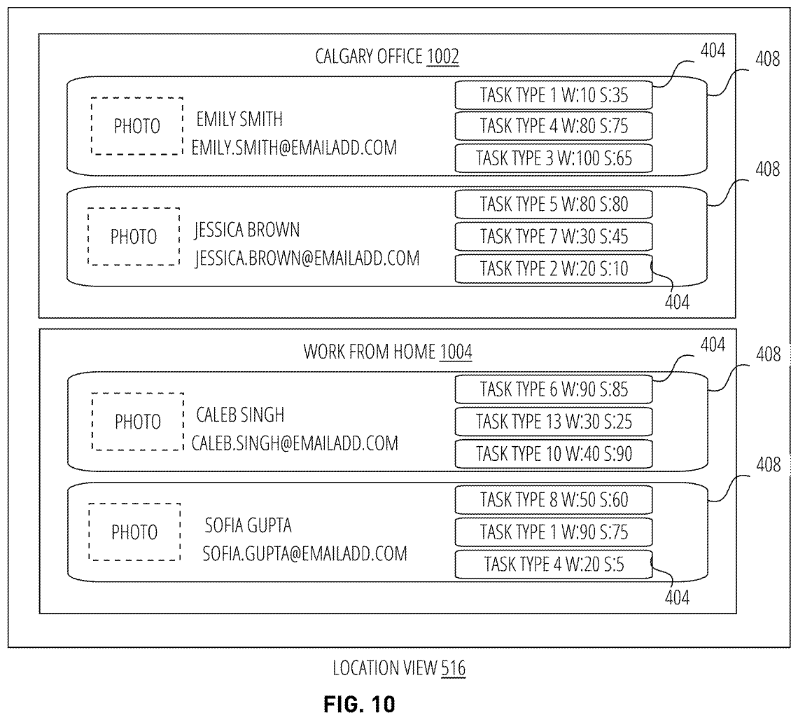

Menu subsection 502 of FIG. 5 may further include a menu option 506 such as location view 516 to allow a manager to view an aspect of the manager module 238 wherein worker profiles 408 and associated task types 404 are shown by location, as shown in FIG. 10. The location may be identified by name, such as Calgary Office 1002, for example. Location information associated with the worker may also be presented along with the address associated with the location. Workers conducting tasks remotely may be identified in the Work from Home 1004 group. Worker profiles 408 associated with the location are grouped together and each show the subset of task types 422 associated therewith accompanied by an adjustable task type priority value 406 value. Therefore, a manager may view which workers are active at specific locations along with the tasks they are working on and an associated adjustable task type priority value 406 which the manager can adjust in order to meet shifting needs.

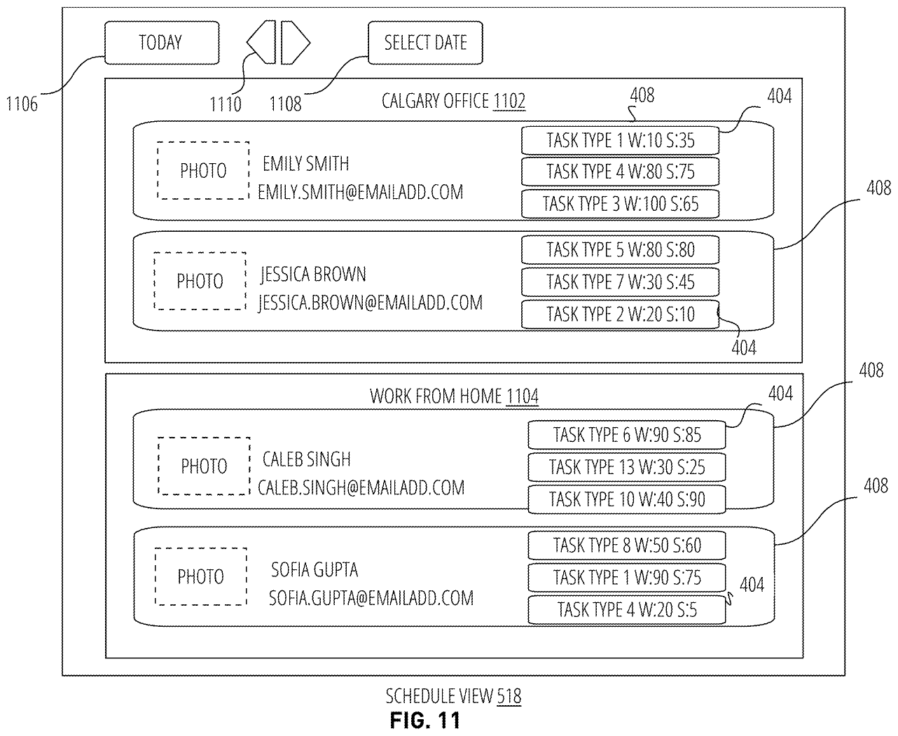

Menu subsection 502 of FIG. 5 may further include a menu option 506 such as schedule view 518 to allow a manager to view an aspect of the manager module 238 wherein the worker profiles 408 of workers scheduled to work on a particular day are shown along with the location at which they are scheduled to work as shown, for example, in FIG. 11. Location information associated with the worker may also be presented along with the address associated with the location. In the aspect shown in FIG. 11, the chosen day is “today”, selectable using Today button 1106. The date may be toggled forward or backward using forward and back buttons 1110 or may be manually entered or selected via a displayed calendar or other means using Date Selector 1108. Changing the date allows the manager to view worker profiles 408 of workers scheduled to work on other days as well as their expected location on that day. Thereby, a manager is able to determine if there are any locations which will be understaffed on a particular day or which will be missing certain critical skills due to lack of workers with requisite task types among the subsets of task types for the workers scheduled to work on that day at that location. The manager may then take action to reallocate workers as needed or to shift the priorities of the organization for that day.

In the aspect shown in FIG. 11, schedule view 518 displays the worker profile along with the subset of task types 422 prioritized for that worker profile 408 and the associated adjustable assignment weighting 418 for each task type in the subset of task types. The task types 404 in the subset of task types 422 may be interacted with by the manager so that the manager may update the subset of task types 422 associated with the worker profile 408 and their associated adjustable assignment weighting 418.

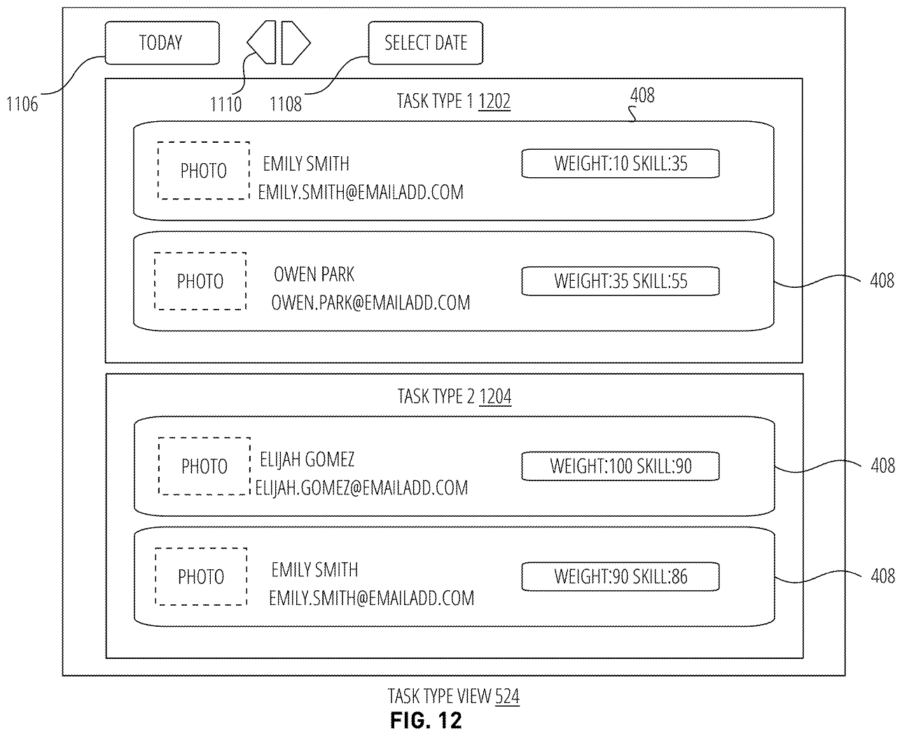

Menu subsection 502 of FIG. 5 may further include a menu option 506 such as task type view 524 to allow a manager to view an aspect of the manager module 238 wherein the worker profiles 408 of workers scheduled to work on a particular day by task type as shown, for example, in FIG. 12. In task type view 524, the manager is able to determine the number of workers available to work on specific task types each day. Thereby, the manager is able to determine if there are any days where certain task types will not be sufficiently addressed due to lack of workers. The manager may then take action to reallocate workers as needed or to shift the priorities of the organization for that day.

In the aspect shown in FIG. 12, task type view 524 displays worker profiles grouped by task type. FIG. 12 only illustrates Task Type 1 and Task Type 2. It should be understood that other task types are visible in task type view 524 and may be viewed by scrolling down the page on display or by changing to a “next page” which will show worker profiles for remaining task types. Each worker profile grouped within each task type includes the adjustable assignment weighting and worker skill weighting for that task type, retrieved from the subset of task types of that worker profile. Accordingly, as shown with worker “Emily Smith”, the same worker profile may appear in different task type groups since the worker profile may include multiple task types within its subset of task types, each with its own associated adjustable assignment weighting and worker skill weighting, as the case may be.

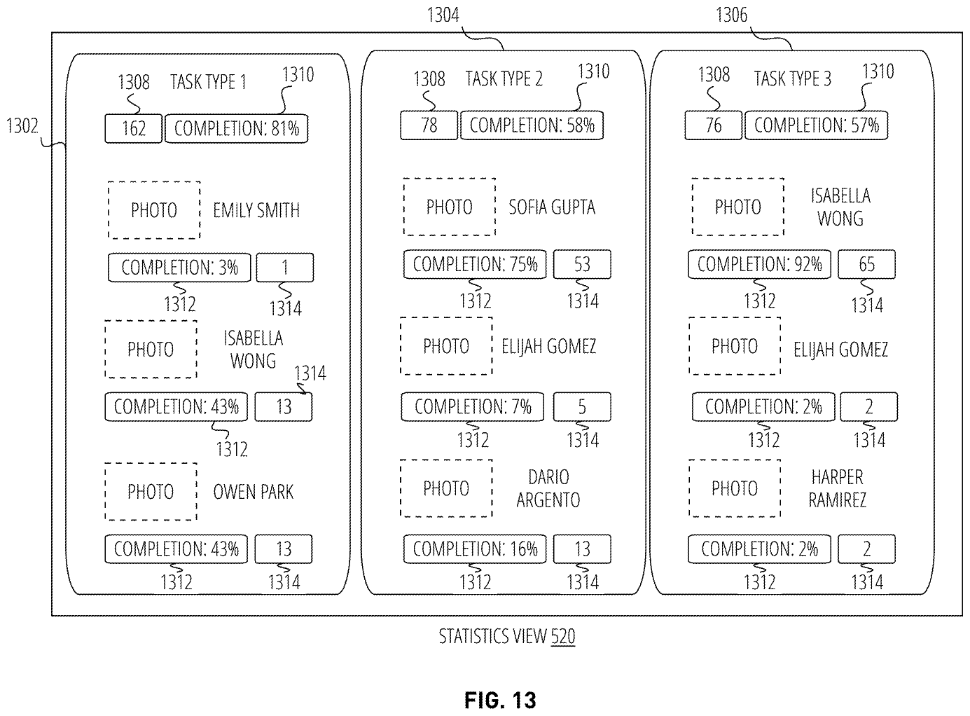

Menu subsection 502 of FIG. 5 may further include a menu option 506 such as statistics view 520 to allow a manager to view statistics or analytics related to task completion and assignment as shown, for example, in FIG. 13. Such tracking may be performed in real time. Historical data may also be viewed by date. Such information may be collected by performance analysis module 220. In the aspect shown, worker profiles 408 are grouped by task type 404. Each task type 1302, 1304, 1306 includes a total number of tasks 1308 within that task type 404. Preferably, each task type 404 also includes an indication of the progress toward completion of a total number of tasks 1308. Such an indication may take the form of progress bar 1310, but may take any other suitable form. The worker profiles 408 listed under each task type each include an identification of the worker as well as a percentage indication 1312 of their contribution toward the total number of tasks 1308 completed. As an alternative to or in conjunction with the percentage indication 1312, a total number of completed tasks 1314 of that task type by the worker may also be displayed. The information presented in the statistics view 520 may be updated periodically or in real-time in order to provide the manager with more recent representations of progress. Such reporting may be done automatically or on command input by the manager.

As discussed above with respect to FIG. 6, the time spent for completion of tasks may be collected by system 100 and recorded within the information of the worker profile. Such information is also accessible via statistics view 520. A manager seeking to review time spent by a worker on tasks that have been completed by that worker may review the list of tasks making up the total number of tasks per task type or as an aggregate across all task types. Thereby, a manager may identify the total number of tasks and time spent by a worker over a period of time and may use this information in employee assessments or other managerial decision making.

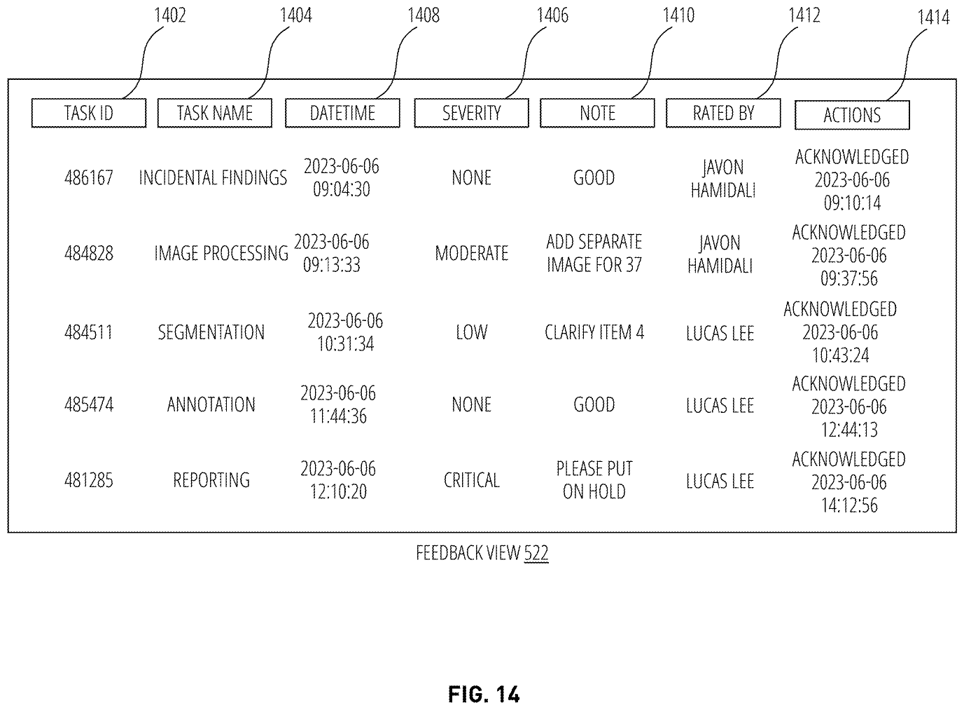

Menu subsection 502 of FIG. 5 may further include a menu option 506 such as feedback view 522 shown in FIG. 14, which allows a downstream worker to assess an upstream task and leave feedback. The downstream worker may be another worker, a worker in a supervisory role, or a manager, for example. Preferably, the person leaving feedback is a manager. In assessing an upstream task, a manager may then take steps to address any concerns themselves and then leave feedback as to what was fixed. In this case, the upstream worker would acknowledge the feedback. In another aspect, the manager may identify the issue and return the task to the upstream worker for completion. The upstream worker then fixes the issue and acknowledges the feedback upon fixing. The manager may then receive a notification that the task issue has been rectified.

In feedback view 522, tasks for which feedback has been provided are shown in a list or table and are identified by task identification number 1402 and task name 1404. The date and time of completion of the task are shown in the datetime column 1408. A manager may identify the severity of the concern in the severity column 1406. A manager may also leave one or more notes 1410 describing the action to be taken or offering constructive comments. The name of the worker leaving feedback is recorded in the rated by column 1412. Actions taken such as acknowledgement of the feedback are recorded in actions column 1414 along with the date and time of the action taken.

It should be understood that feedback view 522 may show feedback items by worker, by task type, by client or by any other metric or dimension associated with the system 100. Accordingly, although FIG. 14 illustrates feedback view 522 from the point of view of feedback on tasks completed by a single worker, it should be understood that feedback associated with tasks completed by one or more workers for a single client may be listed or tasks associated with a single task type. Therefore, feedback is visible along any desired dimension.

One advantage of the feedback system is that quality control is maintained by virtue of downstream checks of completed tasks. Also, managers and workers are able to identify tasks and workers that have high feedback rates. This information may be used to identify candidate workers for further training or retraining, reassessment of roles, improvement of processes or improvement of documentation associated with candidate tasks or task types where necessary.

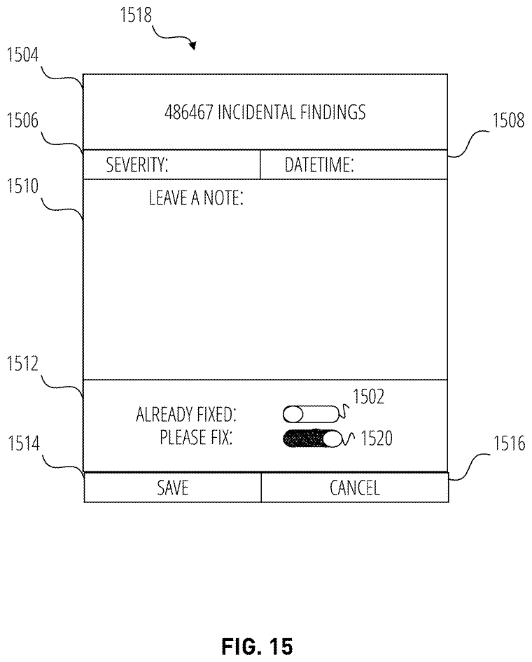

FIG. 15 illustrates an interface 1518 which a downstream worker may use in order to leave feedback to be input into feedback view 522. Interface 1518 includes fillable fields for input of the information used to populate the table of feedback view 522 illustrated in FIG. 14. Interface 1518 includes a field for information to the corresponding columns shown in FIG. 14. Interface 1518 includes fields for inputting the task ID and task name 1504. This information may be input manually. In one aspect, the task ID and task name 1504 are automatically populated with information when the assessing worker selects a task upon which to leave feedback. Interface 1518 likewise includes fields for inputting severity 1506 and datetime 1508. Datetime 1508 may be recorded as only a date or only the time but is preferably recorded with both the date and the time. In another aspect, the date and/or time may be automatically recorded when the feedback is submitted to the system. Interface 1518 may further include message box 1510 for leaving one or more notes 1410. As explained above, a manager may take steps to address any concerns themselves or may identify the issue and return the task to the upstream worker for completion. If the issue has been fixed by the manager, the manager may use toggle switch 1502 to leave an indication to the worker that the issue has already been fixed. If the issue has been passed back to the upstream worker to be fixed, then the manager may indicate this to the upstream worker using toggle switch 1520. Toggle switch 1502 and toggle switch 1520 may operate independently from one another or may be dependent upon one another wherein moving one of the two toggle switches from a first position to a second position will cause the other to move from the second position to the first position or vice versa. Interface 1518 also includes save button 1514 which allows the manager to save and submit feedback view 522 to the system and cancel button 1516 which allows for submission of the feedback to be canceled.

While the invention has been described in terms of specific aspects, it is apparent that other forms could be adopted by one skilled in the art. For example, the methods described herein could be performed in a manner which differs from the aspects described herein. The steps of each method could be performed using similar steps or steps producing the same result but which are not necessarily equivalent to the steps described herein. Some steps may also be performed in different order to obtain the same result. Similarly, the apparatuses and Systems described herein could differ in appearance and construction from the aspects described herein, the functions of each component of the apparatus could be performed by components of different construction but capable of a similar though not necessarily equivalent function, and appropriate materials could be substituted for those noted. Accordingly, it should be understood that the invention is not limited to the specific aspects described herein. It should also be understood that the phraseology and terminology employed above are for the purpose of disclosing the illustrated aspects, and do not necessarily serve as limitations to the scope of the invention.

What is claimed is:

1. A computer implemented method for assigning a task to a worker in an organization, the method comprising:
identifying a plurality of task types within which each task of a plurality of tasks is classifiable;
prioritizing each task type of the plurality of task types relative to one another;
sorting the plurality of tasks into a task queue according to relative priority of the task type with which each task of the plurality of tasks is associated;
identifying a plurality of worker profiles, each worker profile having a subset of task types assignable to a worker associated with the worker profile and an adjustable assignment weighting for each task type of the subset of task types; and,
assigning to one worker one task from the task queue which corresponds with at least one task type of the subset of task types of the worker profile associated with the one worker, the one task being prioritized for assignment relative to other tasks in the task queue according to relative priority of the task type with which the one task is associated and wherein the task type of the one task is weighted according to the adjustable assignment weighting associated with the at least one task type of the subset of task types.

2. The computer implemented method of claim 1 wherein prioritizing each task type of the plurality of task types relative to one another includes associating a task type priority value with each task type of the plurality of task types.

3. The computer implemented method of claim 1 further comprising removing the one task from the task queue after assignment to the one worker.

4. The computer implemented method of claim 1 wherein identifying the plurality of worker profiles further includes obtaining a real-time availability status of each worker profile of the plurality of worker profiles.

5. The computer implemented method of claim 4 wherein the one task in the task queue is assignable only to workers available to receive the one task.

6. The computer implemented method of claim 4 wherein the one worker becomes unavailable to receive further tasks after receiving the one task.

7. The computer implemented method of claim 1 wherein identifying the plurality of worker profiles further includes obtaining a geographic location of the worker associated with the worker profile.

8. The computer implemented method of claim 1 wherein prior to assigning, the method further comprises:
disabling at least one task type of the subset of task types of the worker profile associated with the worker whereby tasks of the disabled at least one task type are unassignable to the one worker as the one task.

9. The computer implemented method of claim 1 wherein assigning the one task includes:
self-assignment of the one task by the worker.

10. The computer implemented method of claim 1 wherein assigning the one task to the one worker is automatic upon completion of a previously assigned task.

11. The computer implemented method of claim 1 wherein prioritizing each task type of the plurality of task types relative to one another includes associating an adjustable urgency weighting with each task type of the plurality of task types, and sorting the plurality of tasks into a task queue is further based on the adjustable urgency weighting associated with each task type.

12. The computer implemented method of claim 1 wherein prioritizing each task type of the plurality of task types relative to one another is further based on metadata.

13. The computer implemented method of claim 12 wherein the metadata includes a status of a prerequisite task.

14. The computer implemented method of claim 12 wherein the metadata further includes a number of tasks in the task queue.

15. The computer implemented method of claim 1 wherein each worker profile of the plurality of worker profiles includes a worker skill weighting associated with each task type of the subset of task types in the worker profile.

16. The computer implemented method of claim 15 wherein assigning to one worker one task from the task queue further comprises:
prioritizing for assignment of the one task one worker among a plurality of workers wherein the one worker has a corresponding worker profile wherein the subset of task types includes a task type corresponding with the task type of the one task and a worker skill weighting associated therewith that is higher than the worker skill weighting associated with the same task type in any of the subset of task types of other worker profiles among the plurality of workers.

17. The computer implemented method of claim 1 further comprising directing the one task to a worker other than the one worker for review of the one task after completion of the one task for providing feedback on the performance thereof.

18. The computer implemented method of claim 17 further comprising directing the one task to the one worker after feedback is provided for acknowledgement of the feedback.

19. A system for assigning a plurality of tasks among workers in an organization comprising:
a task type module for identifying a plurality of task types within which each task of the plurality of tasks is classifiable;
a task type prioritization module for prioritizing each task type of the plurality of task types relative to one another;
a task queue module for sorting the plurality of tasks into a task queue in order of relative priority of the task type with which each task of the plurality of tasks is associated;
a worker profile module for identifying a plurality of worker profiles each having a subset of task types assignable to a worker associated with the worker profile and an adjustable assignment weighting for each task type of the subset of task types; and,
an assignment module for assigning to one worker one task from the task queue which corresponds with at least one task type of the subset of task types of the worker profile associated with the one worker, the one task being prioritized for assignment relative to other tasks in the task queue according to relative priority of the task type with which the one task is associated and wherein the task type of the task is weighted according to the adjustable assignment weighting associated with the at least one task type of the subset of task types.

20. The system of claim 19 wherein the task type prioritization module associates a task type priority value with each task type of the plurality of task types for prioritizing each task type of the plurality of task types relative to one another.

21. The system of claim 19 further comprising a module for removing the one task from the task queue after assignment to the one worker.

22. The system of claim 19 further comprising a worker scheduling module for obtaining a real-time availability status of each worker profile of the plurality of worker profiles.

23. The system of claim 22 wherein the one task in the task queue is assignable only to workers available to receive the one task.

24. The system of claim 22 wherein the one worker becomes unavailable to receive further tasks after receiving the one task.

25. The system of claim 19 further comprising a worker location module for obtaining a geographic location of the worker associated with the worker profile.

26. The system of claim 19 wherein the worker assignment module is configured to disable at least one task type of the subset of task types of the worker profile associated with the worker whereby tasks of the at least one disabled task type are unassignable to the one worker as the one task from the task queue.

27. The system of claim 19 wherein the one worker self-assigns the one task via the worker assignment module.

28. The system of claim 19 wherein assignment of the one task to the one worker is automatic upon completion of a previously assigned task.

29. The system of claim 19 further comprising:
a task urgency module for associating an adjustable urgency weighting to each task type of the plurality of task types, the task urgency module being in data communication with the task queue module wherein the task queue module sorts the plurality of tasks into the task queue further based on the adjustable urgency weighting associated with each task type is further based on the adjustable urgency weighting.

30. The system of claim 19 wherein the task type prioritization module further prioritizes each task type of the plurality of task types relative to one another based on metadata

31. The system of claim 30 wherein the metadata includes a status of a prerequisite task.

32. The system of claim 30 wherein the metadata includes a number of tasks in the task queue.

33. The system of claim 19 wherein each worker profile of the plurality of worker profiles includes a worker skill weighting associated with each task type of the subset of task types in the worker profile.

34. The system of claim 33 wherein the worker assignment module prioritizes for assignment of the one task one worker among a plurality of workers wherein the one worker has a corresponding worker profile wherein the subset of task types includes a task type corresponding with the task type of the one task and a worker skill weighting associated therewith that is higher than the worker skill weighting associated with the same task type in any of the subset of task types of other worker profiles among the plurality of workers.

35. The system of claim 19 further comprising:
a manager module in data communication with and configured for enabling a manager to make manual adjustments in at least one of the task type prioritization module, the worker assignment module, the task queue module and the worker profile module.

36. The system of claim 19 further comprising:
a feedback module for directing the one task to a worker other than the one worker for review of the one task after completion of the one task for providing feedback on the performance thereof.

37. The system of claim 36 wherein the feedback module is configured for directing the one task to the one worker after feedback is provided for acknowledgement of the feedback.
